(19) United States
(12) Patent Application Publication
(10) Pub. No.: US 2008/0055157 A1
(43) Pub. Date: Mar. 6, 2008

(54) Cooperative passive radar system

(76) Inventors: Zafer Sahinoglu, Watertown, MA (US); Sinan Gezici, Princeton, NJ (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/514,524

(22) Filed: Sep. 1, 2006

(51) Int. Cl. G01S 3/02

(52) U.S. Cl. 342/450

(57) ABSTRACT

A method and system detects a target in a cooperative passive radar system. In each of multiple passive sensors, signals are detected that emanate from a target. Information is extracted from the signals and broadcast to other passive sensors. The sensors update parameters according to the information to improve a likelihood of receiving the signals and to increase a probability of detecting the target. The information is also transmitted to a central processor. The central processor determines a position of the target.

### FIELD OF THE INVENTION

This invention relates generally to a radar system for detecting targets, and measuring position, velocity and direction of targets, and more particularly to passive cooperative radar systems including passive sensors and a processing center.

### BACKGROUND OF THE INVENTION

FIG. 1A shows a prior art passive radar system 105. Signals emanate from a target 90. The emanating signals 100 can be transmitted or reflected by the target. The signals 100 are received by multiple passive sensors (PSs) 180. Each sensor can include one or more antennas 181. The PSs 180 process the signals to extract information. The information can be a time of arrival (TOA) of the signals 100. The TOA information are forwarded 182 to a processing center (PC) 160. The PC can then locate the target 90 using trilateration.

FIG. 1B shows further details of the prior art passive radar system 105. The signals r(t) 100 from the target 90 passes through wireless channels h₁(t) 110 and h₂(t) 120 to be received as signals r₁(t) 115 and r₂(t) 125 by PSs 180, respectively. Each PS forwards the received signal to a processing center (PC) 160 along with a time stamp (TOA). The PC 160 includes a correlator unit 140, which correlates signals 182 r₁′(t) and r₂′(t), and a peak detector 150, which estimates a time difference of arrival (TDOA) from the output of the correlator unit according to an integration interval T 190.

For the TDOA techniques, the difference between the arrival times of the signal 100 from the target 90 at each pair of PSs is used by the PC to determine a hyperbola on which the target lies. At least four PSs are required to determine the position of the target.

U.S. Pat. No. 6,275,283 describes passive ranging to a source of known spectral emission to cue an active radar system. That system uses optical PSs, which provide ranging and rate information to the active radar system. By this way, the active radar can achieve a better resolution with fewer transmissions.

Another passive radar system is described in U.S. Pat. No. 5,444,451. That system uses a single passive radar device with sensors to determine the position of the target. By measuring the inter-sensor delay times, the direction of arrival (DOA) of the signal from the target signal can be determined for positioning purposes.

In U.S. Pat. No. 5,323,161, a passive radar system distinguishes pulses coming from the target from pulses from other sources. Confidence values are determined for the received pulses to identify the pulses of the target without the need for any reference pulse. With this technique, a target can be detected from its pulse structure.

U.S. Pat. No. 5,280,294 describes a passive radar system in which the range to a target and to a non-cooperative scanning radar is estimated. The PS components include a passive antenna array with beam-forming means and a switching matrix to provide separate outputs.

In all of the above passive radar systems, there is no cooperation between the PSs.

U.S. Patent Publication 20050052315 describes cooperation between onboard radio frequency sensors on flying airplanes. Because the planes are flying, their positions relative to each other needs to be mutually exchanged. In addition, the frequency and time measurement windows of the sensors on the two airplanes must be synchronized so that the measurement takes place in one frequency band, at the same time. That system does not use a central processor. Therefore, each airplane determines the target parameters independently. The airplanes do not share the received signals.

It is desired to use relatively low cost, low power, ground based sensors for passive radar detection. This means that the amount of processing performed by each sensor should be minimized. For a passive radar system, it can be time and power consuming to transmit continuously all the signals received by the PSs to the PC for TDOA determination. Determine all target parameters in the PSs directly would also require more complex processing.

### SUMMARY OF THE INVENTION

The embodiments of the invention provide a passive radar system in which passive sensors (PSs) cooperatively perform initial acquisition and analysis of radar signals. The PSs extract information from the radar signals, and forward portions of the signals and the extracted information to other PSs and a processing center (PC).

To increase the detection capability of the PSs and the reliability of the information that the PSs send to the PC, a cooperative structure is provided. Each PS broadcasts information to other PSs when a target is detected. Using the broadcast information, the other PSs can cooperatively adapt receiver parameters in order to perform better detection and localization of the target.

Specifically, a method and system detects a target in a cooperative passive radar system.

In each of multiple passive sensors, signals are detected that emanate from a target. Information is extracted from the signals and broadcast to other passive sensors.

The sensors update parameters according to the information to improve a likelihood of receiving the signals and to increase a probability of detecting the target.

The information is also transmitted to a central processor. The central processor determines a position of the target.

### BRIEF DESCRIPTION OF THE DRAWINGS

FIG. 1A is a block diagram of a prior art passive radar systems;

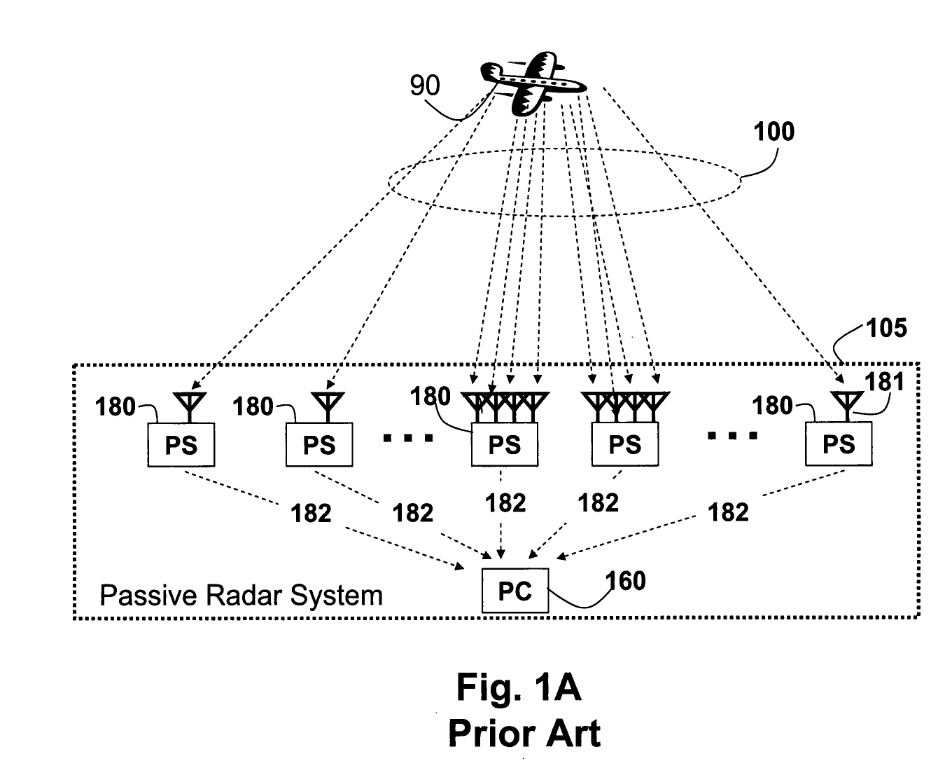

FIG. 1B is a block diagram of details of the prior art passive radar systems of FIG. 1A;

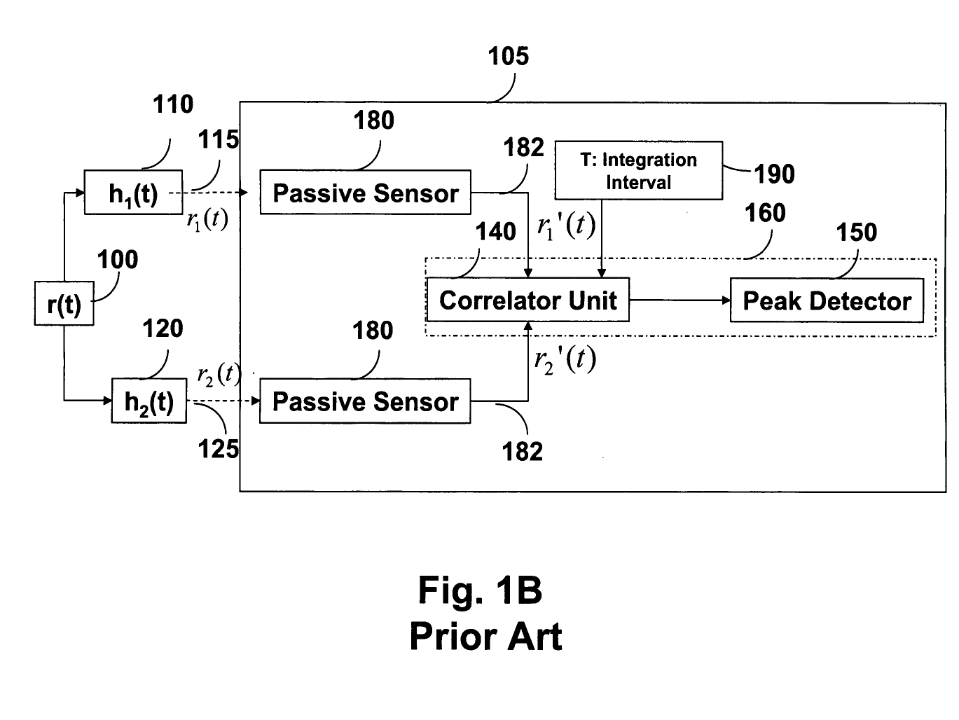

FIG. 2A is a block diagram of a cooperative passive radar system according to an embodiment of the invention;

FIG. 2B is a block diagram of details of the cooperative passive radar system according to an embodiment of the invention;

FIG. 3 is a block diagram of a passive sensor in the cooperative passive radar system with an antenna array according to an embodiment the invention; and

FIG. 4 is a block diagram of a passive sensor in the cooperative passive radar system with a single antenna according to an embodiment the invention.

### DESCRIPTION OF THE PREFERRED EMBODIMENT

The embodiments of the invention provide a cooperative passive radar system that includes multiple passive sensors (PSs) and a processing center (PC). The system can detect and locate targets. The system can use pulse-based or non-pulse-based signals where characteristics of the signals, such as duration, carrier frequency, modulation, may be unknown.

Multiple PSs detect signals emanating from a target. By emanating, we mean the signals are either transmitted or reflected by the target. Information is extracted from the signals. The information is broadcast to other PSs and the PC. The other PSs use the information to update internal parameters. These updates enable the other PSs to improve a likelihood of receiving the signals and to increase a probability of detecting the target. For a PS with a single antenna, parameter update can be in the form of adjusting a threshold γ for signal detection. For PSs with antenna arrays, the updating can adjust an antenna pattern to focus on the target.

Cooperative Passive Radar System

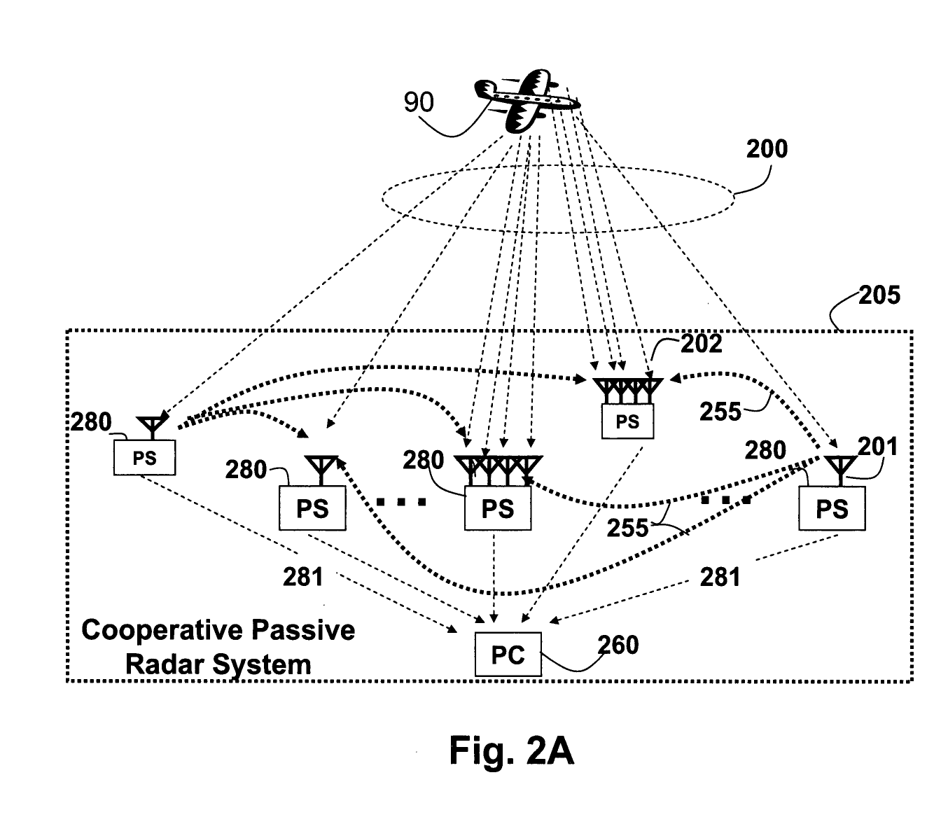

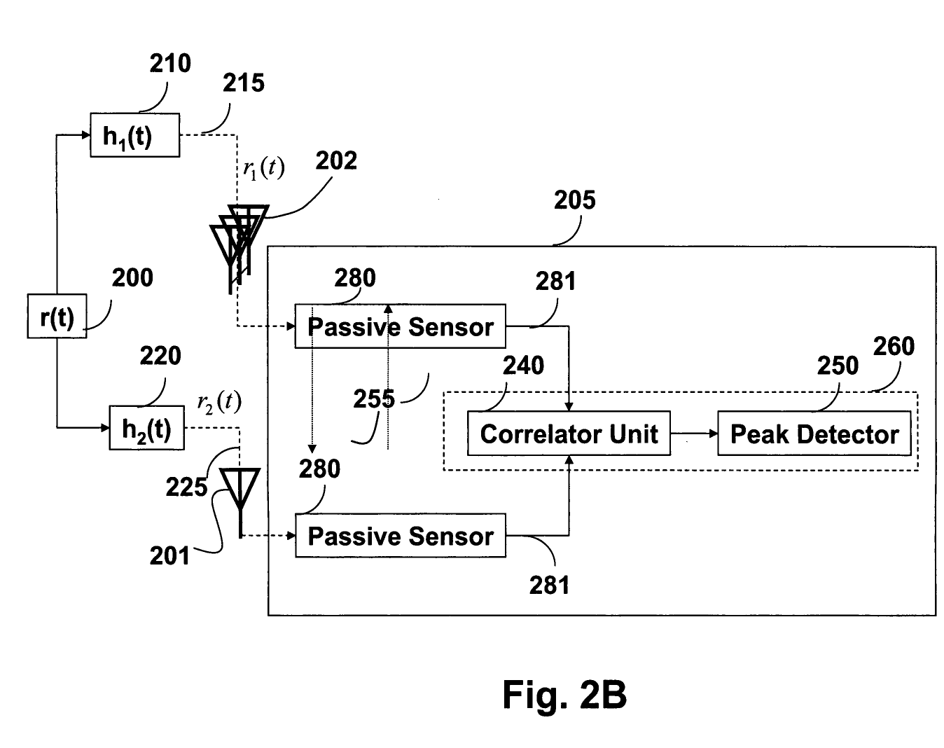

FIGS. 2A-2B shows a cooperative passive radar system 205 according to an embodiment of the invention. A target signal r(t) 200 passes through channels h₁(t) 210 and h₂(t) 220. Signals r₁(t) 215 and r₂(t) 225 are received by PSs 280, respectively. It should be noted that the system can include more than two PSs.

Each PS broadcasts information 255 extracted from the respective received signals when a target is detected. Target signal related information 281 is also sent to the PC 260.

The information can include a portion of the received target signal if the PS includes a single antenna 201. If the PS includes an antenna array 202, then the information can also include an azimuth angle and an elevation angle to the target. In both cases, the PC 260 cross-correlates the target signals from cooperating PSs 280 to estimate the TDOA of the signal from the target. It should be noted, that if the information includes the angular data, only two sensors are sufficient to determine the position of the target using triangulation. Position calculations using timing information only requires four sensors using trilateration.

The PC 260 includes a correlator unit 240 that correlates the signals 281 from the PSs 280, and a peak detector 250 that estimates the time difference of arrival (TDOA) from an output of the correlator unit 240.

Passive Sensor with Antenna Array

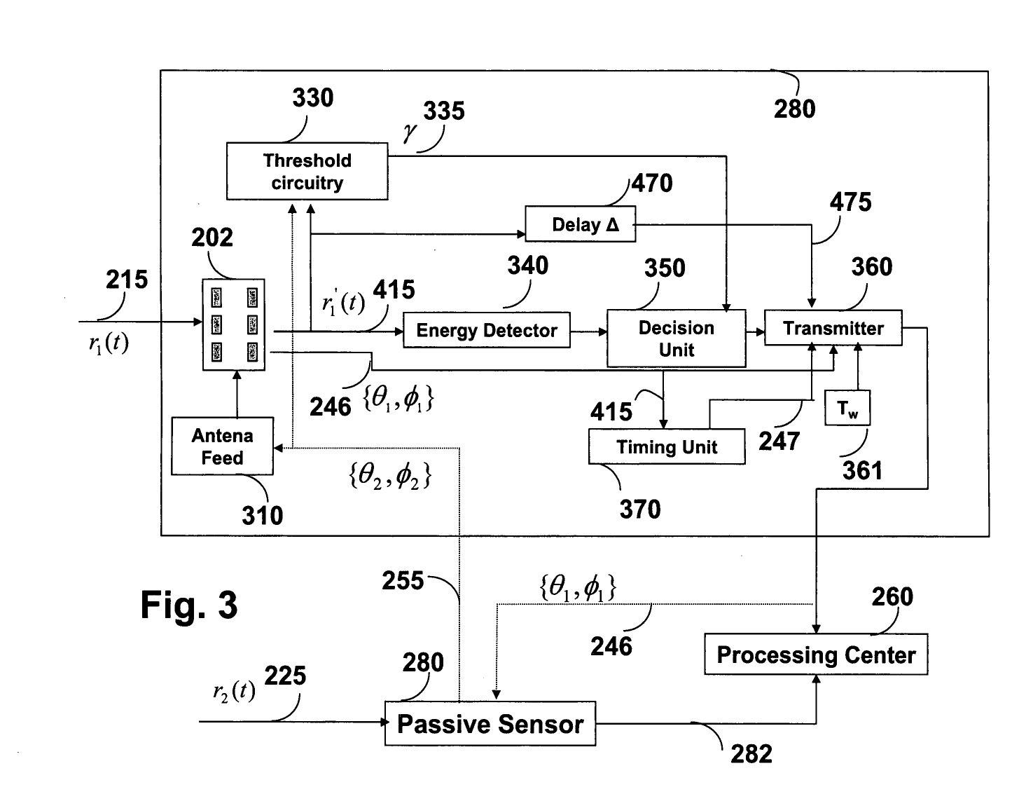

FIG. 3 shows the detailed architecture of the PS 280. The signal r₁(t) 215 from the target enters the antenna array 202. An antenna feed 310 can be used to adjust the beam forming pattern of the antenna array 202. This can be accomplished by phase shifting the received signal appropriately. The antenna feed optimizes the receive RF chain to improve the detection of the target based on information received from other cooperating passive sensors.

An output of the antenna array 202 includes signals r₁′(t) 415, azimuth angle and elevation angles 246 {θ₁,φ₁} to the target. The angles can be determined using conventional phase sensitive circuits.

The signals r₁′(t) 415 are fed to an energy detector 340, and also into a threshold circuit 330, which generates a threshold level γ 335 by using r₁′(t) 415 and the feedback information 255, if any, from other PSs. The feedback information can include the azimuth and elevation angles {θ₂,φ₂} 255 detected by the PS 280 that provides the feedback.

The feedback of the azimuth angle and elevation angles can also be used to adjust settings of the antenna feed 310 to improve signal reception.

A decision unit 350 receives the threshold value γ 335 and the output of the energy detector 340. If the energy level is higher than the threshold γ 335, then the decision unit 350 activates the transmitter 360 and also drives a timing unit 370.

When the transmitter 360 is activated, a certain part of the delayed version of the received signal r₁′(t) 415, r₁′(t−Δ) 475, where Δ 470 is a length of the delay, is transmitted to the PC 260. The other information that is transmitted includes the azimuth angle and elevation angles 246 {θ₁,φ₁} and a timestamp 247 of the signal detection time prepared by a timing unit 370.

The part of the signal 475 that is being transmitted is determined by the window length T_{w} 361. The window length can be in the order of microseconds. The transmitter 360 transmits the signal r₁′(t−Δ) during t ε [0,T_{w}], where Δ and T_{w} are design parameters, after being triggered by the decision unit 350.

Upon activation of the transmitter 360, the azimuth and elevation angles 246 are also forwarded to the other PS 280.

Passive Sensor with Single Antenna

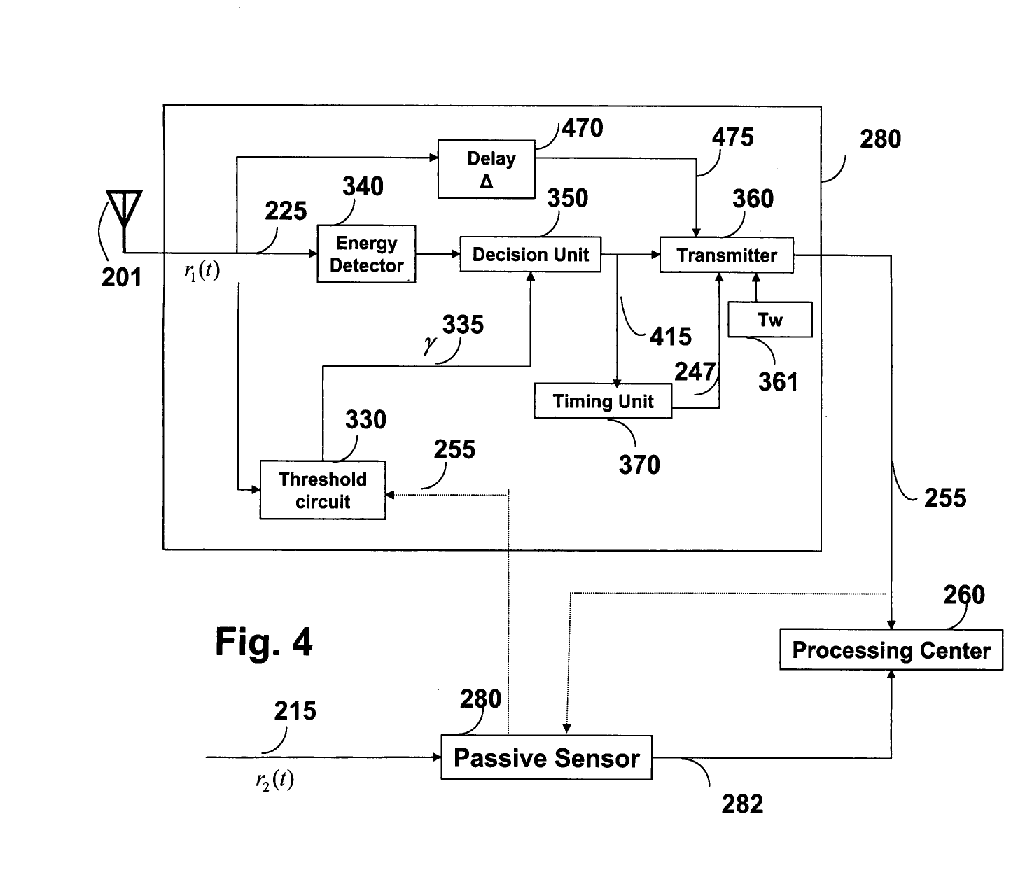

FIG. 4 shows the PS with a single antenna 201. The received signal r₁(t) 225 is fed to the energy detector 340 and to the threshold circuit 330. The threshold circuit sets the threshold γ 335 based on feedback information 255, if available, from the other PSs 280 and the received target signal r₁(t)

225. The decision unit 350 compares the energy level returned by the energy detector 340 to the threshold γ 335 returned by the threshold circuitry 330.

If the threshold γ is exceeded, the transmitter 360 is activated, and then a certain part of the delayed version of the target signal r₁(t) 225, r₁′(t−Δ) 475, where Δ 470 is the delay length, is transmitted to the PC 260 together with the time stamp 247 generated by the timing unit 370. The time stamp transmitted by the transmitter 360 is also sent to the other PSs 280, and is used as information to improve their detection performance. The part of the signal that is transmitted is determined by the window length T_{w} 361. The transmitter 360 transmits the signal r₁′(t−Δ) during t ε [0,T_{w}], where Δ and T_{w} are design parameters, after being triggered by the decision unit.

Cooperation Between Passive Sensors

According to the invention, cooperation strategy varies depending on whether the passive sensor has an antenna array or not.

Passive Sensors with Antenna Arrays

The PS that detects the presence of a target broadcasts a feedback message to other PSs specifying the azimuth and elevation angles of the target with respect to the position of the sensor. Because the PSs know their relative positions, this angular information provides information about the target position.

A PS receiving feedback from other PSs can adjust cooperatively its antenna gain pattern according to the target azimuth and elevation feedback provided by the other PSs to focus on the target, and/or adjust its detection threshold in order to increase the probability of target detection.

Passive Sensors with Single Antennas

The PS that detects the target broadcasts feedback to the other PSs. Upon receiving the feedback, the other PSs adjust their parameters to increase probability of detection, unless the other PSs have already detected the target. One way of parameter adjustment is to lower the detection threshold to increase detection probability at the expense of increased probability of false-alarm.

### EFFECT OF THE INVENTION

A cooperative passive radar system includes passive sensors with either single antennas or antenna arrays. The cooperation among the passive sensors provides a number of advantages compared to conventional non-cooperative passive radar systems. The detection probability of targets is increased by adjusting system parameters according to feedback among the PSs. By signal windowing, the amount of data that needs to be transferred to the processing center is reduced.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A cooperative passive radar system comprising:
a plurality of passive sensors, each passive sensor configured to detect signals emanating from a target, each passive sensor further comprising:
means for extracting information from the signals;
means for broadcasting the information to other passive sensors; and
means for updating parameters of the passive sensor according to the information to improve a likelihood of receiving the signals and to increase a probability of detecting the target.

2. The method of claim 1, in which each passive sensor further comprises:
means for receiving the information broadcast by the other sensors.

3. The system of claim 1, in which the emanated signals are pulse-based signals, where characteristics of the signals are unknown.

4. The system of claim 1, in which the information is associated with a timestamp for the signals at each of the passive sensors, and each passive sensor further comprises:
means for transmitting the information to a central processor to determine a position of the target.

5. The system of claim 1, in which the parameters include threshold.

6. The system of claim 1, in which the information includes an azimuth angle and an elevation angles to the target.

7. The system of claim 1, in which the information includes a part of the received signal, and further comprising:
means for transmitting the information to a central processor to determine a position of the target.

8. The system of claim 1, in which the information includes an azimuth angle and an elevation angles to the target, and further comprising:
means for transmitting the information to a central processor to determine a position of the target.

9. The system of claim 1, in which a particular passive sensor further comprises:
an antenna array; and
means for adjusting a beam forming pattern of the antenna array according to the information.

10. The system of claim 1, in which the information includes a windowed version of the signals.

11. A method, for detecting a target in a cooperative passive radar system, comprising, in each of a plurality of passive sensors, the steps of:
detecting signals emanating from a target;
extracting information from the signals;
broadcasting the information to other passive sensors; and
updating parameters of the passive sensor according to the information to improve a likelihood of receiving the signals and to increase a probability of detecting the target.

12. The method of claim 11, wherein in each passive sensor the method further comprising the steps of:
receiving the information broadcast by the other sensors; and
updating the information with the broadcast information.

13. The method of claim 11, in which the information is associated with a timestamp for the signals at each of the passive sensors, and further comprising:
transmitting the information from at least four passive sensors to a central processor to determine a position of the target.

14. The method of claim 11, in which the information includes a threshold for signals detection.

15. The method of claim 11, in which the information includes an azimuth angle and an elevation angles to the target.

16. The method of claim 11, in which the information includes a part of the received signal, and further comprising:
transmitting the information to a central processor to determine a position of the target.

17. The method of claim 11, in which the information includes an azimuth angle and an elevation angles to the target, and further comprising:
transmitting the information from at least two passive sensors to a central processor to determine a position of the target.

18. The method of claim 11, in which a particular passive sensor further comprises:
an antenna array; and
adjusting a beam forming pattern of the antenna array according to the information.

19. The system of claim 11, in which the information includes a windowed version of the signals.
